(19) United States
(12) Patent Application Publication
(10) Pub. No.: US 2019/0219398 A1
(43) Pub. Date: Jul. 18, 2019

(54) ANALYSIS METHOD FOR GLOBAL POSITIONING SYSTEM

(71) Applicant: NATIONAL TSING HUA UNIVERSITY, HSINCHU (TW)

(72) Inventors: HUNG-MIN SUN, Hsinchu City (TW); MIN-YAO SHIH, Tainan City (TW)

(21) Appl. No.: 15/964,196

(22) Filed: Apr. 27, 2018

(30) Foreign Application Priority Data
Jan. 18, 2018 (CN) 201810049412.2

(51) Int. Cl. G01C 21/10; G01C 21/00; G01C 21/20; G06K 9/62

(52) U.S. Cl. CPC G01C 21/10; G06K 9/6269; G01C 21/20; G01C 21/005

(57) ABSTRACT

The present disclosure relates to an analysis method for a global positioning system. The analysis method includes steps of operating a mobile device including an accelerometer, a magnetometer and a GPS data receiver, and using the GPS data receiver to receive GPS data, and using the accelerometer to obtain acceleration data, and using the magnetometer to obtain magnetic data; combining and converting the GPS data, the acceleration data and the magnetic data into a direction error value, a position error value, and a movement distance error value; and executing a support vector machine system installed in a server, to compare the direction error value, the position error value and the movement distance error value with a predetermined threshold for classification. The technical solution of the present disclosure is able to detect GPS spoofing attacks and perform correction position data, so as to improve security in the user's personal safety.

### CROSS-REFERENCE TO RELATED APPLICATION

This application claims the benefit of Chinese Patent Application No. 201810049412.2, filed on Jan. 18, 2018, in the State Intellectual Property Office, the disclosure of which is incorporated herein in its entirety by reference.

### BACKGROUND OF THE INVENTION

### 1. Field of the Invention

The present disclosure relates to an analysis method for a global positioning system, more particularly to an analysis method which is able to detect and correct spoofing attacks for global positioning system.

### 2. Description of the Related Art

After Japan announced that the global positioning system (GPS) receiving function becomes a basic specification for 3G cell phone in 2004 and the all newly introduced cell phones under the U.S. security regulations of 2005 are required to have simple positioning functions for rescue units to find the location of the caller in time, GPS-related industries are developed rapidly. According to a research report by ABI Research, a total output value of personal GPS tracking devices and related location tracking services in 2017 is expected to exceed $1 billion with a compound annual growth rate of over 40%. Therefore, researches and developments related to positioning system have huge business opportunities.

In recent years, most of the positioning system-related application devices use the GPS in the civil signal band. However, the GPS in civil signal bands is hard to resist GPS spoofing, so it results in the risk of various devices using GPS in civilian signal bands, for example, the GPS spoofing manner includes the actions of sending a wrong address signal to trick person to sparsely populated area, making operation of a UAV fail or crash, or making GPS time synchronization related systems fail. Furthermore, GPS spoofing attacks have become more widespread because software-defined radio (SDR) devices, which are cheap and easily accessible, can be used to start GPS spoofing attacks.

Nowadays, a dead reckoning (DR) system that can receive wireless WiFi signal indoors can replace the GPS function. However, the dead reckoning system receiving the WiFi signal may be subject to regional limitations. For this reason, a pedestrian dead reckoning (PDR) system using an accelerometer and a magnetometer, which are built in a mobile device, is developed for positioning. However, it is hard for the PDR system to directly overcome and correct GPS spoofing attacks. Therefore, what is needed is to develop a method of using PDR system to detect and correct GPS spoofing attacks.

### SUMMARY OF THE INVENTION

In order to solve the above problems in the prior art, an objective of the present disclosure is to provide an analysis method for a global positioning system, so as to solve the problems that the conventional solution is unable to simultaneously detect and correct positioning signals and cause personal safety hazards to users.

According to an embodiment, the present disclosure provides an analysis method for a global positioning system. The analysis method includes steps of operating a mobile device comprising an accelerometer, a magnetometer and a GPS data receiver, and using the GPS data receiver to receive GPS data, using the accelerometer to obtain acceleration data, and using the magnetometer to obtain magnetic data; transmitting the GPS data, the acceleration data and the magnetic data from the mobile device to a server; combining and converting the GPS data, the acceleration data and the magnetic data into a direction error value, a position error value and a movement distance error value; executing a support vector machine (SVM) system installed in the server, to compare the direction error value, the position error value and the movement distance error value with a predetermined threshold for classification, wherein the predetermined threshold is adjustable upon a user's height and gait; transmitting, from the server, a confirmation signal or not transmitting any signal when the direction error value, the position error value and the movement distance error value are classified into true values; transmitting estimated position data from the server to the mobile device for correction when the direction error value, the position error value and the movement distance error value are classified into false values, and defining the GPS data of the position error value and/or the movement distance error value classified into true values as final GPS data, and combining and converting the final GPS data with the acceleration data and the magnetic data to generate the estimated position data.

Preferably, the direction error value is a difference between the magnetic data and estimated magnetic data calculated according to an equation 1, and the equation 1 is as following:

$$H ( t ) = arctan 2 ( \frac{Lat ( t ) - Lat ( t - 1 )}{γ} , \frac{Lon ( t ) - Lon ( t - 1 )}{γ} )$$

wherein H(t) represents the estimated magnetic data at time t, Lat(t) represents a latitude at time t, Lat(t−1) represents a latitude at time (t−1), Lon(t) represents a longitude at time t, Lon(t−1) represents a longitude at time (t−1), γ represents a GPS conversion constant, and arctan represents an arctangent of the direction.

Preferably, the position error value is a coordinate difference between the GPS data and the estimated position data.

Preferably, the movement distance error value is an absolute value difference between the GPS data and the estimated position data.

Preferably, the estimated position data is calculated according to estimated step count data, estimated step length data, estimated magnetic data and the final GPS data.

Preferably, the estimated step count data matches estimated step count conditions, and the estimated step count conditions include that sampling rate is 0.1 seconds, one step occurs when an accumulated component of the acceleration data in a z direction reaches a local maximal value and exceeds one third of a mean of amplitude, only one step occurs in every 0.3 second, and a local maximal value of the acceleration data is higher than 9.8 g/s².

Preferably, the estimated step length data calculated according to an equation 2, and the equation 2 is as following:

StepLength=α·P+β·ω+C

wherein P and ω represent an amplitude of acceleration and a walking frequency obtained by the acceleration data, respectively, α and β are constants representing the user's gait, and C is a constant representing the user's height.

The technical effect of the analysis method for the global positioning system according to the present disclosure is that, in the absence of a WiFi signal, the analysis method can detect GPS spoofing attacks by using the accelerometer and the magnetometer built in the mobile device and classifying the GPS spoofing attacks in cooperation with the SVM system, and the analysis method can further correct the position signal, thereby ensuring the user's location information security.

### BRIEF DESCRIPTION OF THE DRAWINGS

The structure, operating principle and effects of the present disclosure will be described in detail by way of various embodiments which are illustrated in the accompanying drawings.

FIG. 1 is a schematic flowchart of an analysis method for a global positioning system (GPS), in accordance with an embodiment of the present disclosure.

FIG. 2 is a schematic view of a mobile device applied in an analysis method for GPS, in accordance with an embodiment of the present disclosure.

FIG. 3 is a schematic view showing estimated magnetic data in an analysis method for GPS, in accordance with an embodiment of the present disclosure.

FIGS. 4 and 5 are analysis views showing estimated step count data in the analysis method for GPS, in accordance with an embodiment of the present disclosure.

FIG. 6 is an analysis view showing estimated step length data in the analysis method for GPS, in accordance with an embodiment of the present disclosure.

FIG. 7 is an analysis view showing estimated step length data in the analysis method for GPS, in accordance with an embodiment of the present disclosure.

FIGS. 8A and 8B are separability analysis views of the analysis method for GPS, in accordance with an embodiment of the present disclosure, respectively.

FIGS. 9A and 9B are test analysis views of the analysis method for GPS, in accordance with an embodiment of the present disclosure, respectively.

FIGS. 10A and 10B are test views of the analysis method for GPS, in accordance with an embodiment of the present disclosure, respectively.

### DETAILED DESCRIPTION OF THE PREFERRED EMBODIMENTS

The following embodiments of the present disclosure are herein described in detail with reference to the accompanying drawings. These drawings show specific examples of the embodiments of the present disclosure. It is to be understood that these embodiments are exemplary implementations and are not to be construed as limiting the scope of the present disclosure in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms “first”, “second”, “third”, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on”, “connected to” or “coupled to” another element or layer, it can be directly on, connected or coupled to the other element or layer, or intervening elements or layers may be present. In contrast, when an element is referred to as being “directly on”, “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

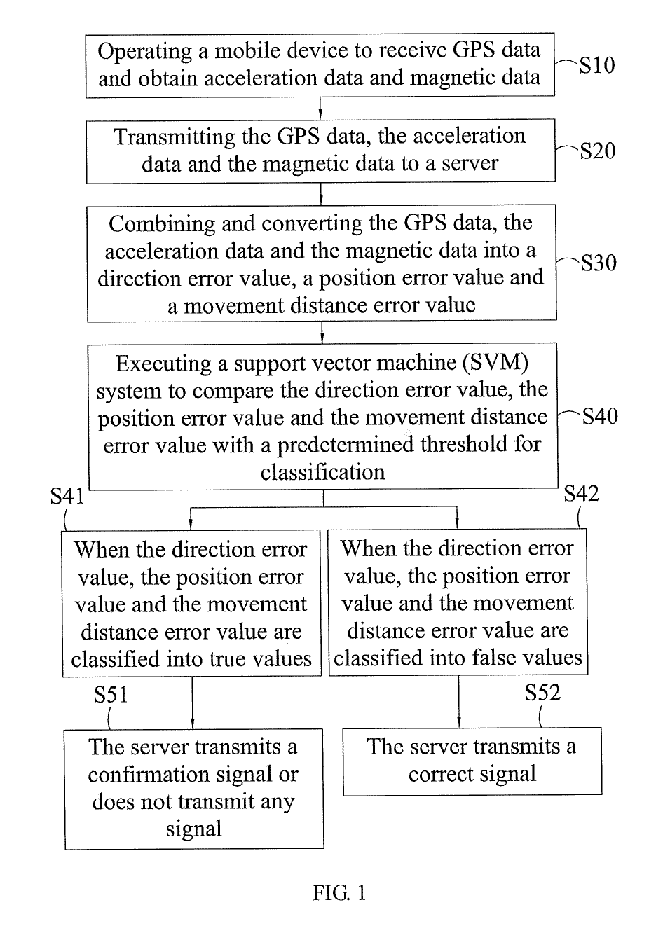

Please refer to FIG. 1, which is a schematic flowchart of an embodiment of an analysis method for a global positioning system, according to the present disclosure. In a step S10, a mobile device including an accelerometer, a magnetometer and a GPS data receiver is operated, and GPS data is received by the GPS data receiver, acceleration data is acquired by the accelerometer, and magnetic data is acquired by the magnetometer. Almost all mobile devices currently on the market are equipped with the accelerometers, the magnetometers and the GPS data receivers, so almost any user holding a variety of mobile devices can use the analysis method for GPS according to the present disclosure. As a result, the technical solution of the present disclosure has a wide range of applications.

In steps S20 and S30, the GPS data, the acceleration data and the magnetic data are transmitted from the mobile device to a server. The GPS data, the acceleration data and the magnetic data are combined and converted into direction error values, position error values and movement distance error values for subsequent classification.

In a step S40, a support vector machine (SVM) system installed in the server is operated to compare the direction error value, the position error value and the moving distance error value with a predetermined threshold for classification. The predetermined threshold can be adjusted according to a user's height and gait. According to classification, the analysis method can detect whether GPS spoofing attacks occur. In addition, the predetermined threshold may be an experimental value obtained from the user's height and the user's gait. According to different classification results, steps S41 and S51, and steps S42 and S52 are executed, respectively.

In steps S41 and S51, when the direction error value, the position error value and the moving distance error value are classified into true values, a server transmits a confirmation signal or does not transmit any signal, and it indicates that the analysis method for the global positioning system of the present disclosure does not modify the GPS data received by the GPS data receiver in the mobile device because the global positioning system is not attacked by GPS spoofing action.

In steps S42 and S52, when the direction error value, the position error value and the movement distance error value are classified into false values, the server transmits a correct signal which is an estimated position data to the mobile device. The GPS data in which the last position error value and/or movement distance error value is classified as the real values is served as the last GPS data, and the estimated position data is generated according to the last GPS data, the acceleration data and the magnetic data. It indicates that the analysis method for the global positioning system of the present disclosure is able to detect the GPS spoofing attack and perform correction for positioning when the global positioning system is subject to GPS spoofing attacks.

Furthermore, an accuracy of the GPS signal including the latitude and longitude of the mobile device is usually about 4.7 meters in radius and more accurate in an open area that is unaffected by buildings or other environmental factors. The GPS-related API (Application Program Interface) can use LocationManager through Android device or use CLLocationManager through iOS device. Therefore, in one embodiment of the present disclosure, the GPS component built in iOS device is used, and the GPS function can be implemented in the iOS device with Swift and the API selected as CLLocationManager.

The GPS signal includes a coordinate with the three axes and time, so at least four satellites are required to calculate the position signal. The GPS spoofing attacks are to affect the location and time included in the GPS signal. Generally, the software-defined radio (SDR) platform can be used to generate the GPS spoofing signal.

In an embodiment of the present disclosure, in order to verify whether the analysis method of the present disclosure is capable of detecting GPS spoofing attacks, the HackRF, which has lower cost and is relatively easy to obtain, is selected as an SDR platform to test the effect of the present disclosure. The instructions of the HackRF are as follows:

$hackrf_transfer -t gpssim.bin -f 1575420000 -s

2600000 -a 1 -x 30 -R

Where:

-t filename: file that contain the signal data

-f frequency: frequency in Hz

-s sample rate: sample rate in Hz

-a 1: enable RX,TX RF amplifier

-x dB: gain dB, 0-47 dB

-R: repeat mode

The GPS spoofing signal can be generated by using the original coding gps-sdr-sim, the instructions of the original coding gps-sdr-sim are as follows:

$ gps-sdr-sim -e brdc3540.14 n -l 30.286502, 120.032669, 100

Where:

-e filename: RINEX navigation file for GPS ephemerides

-l latitude,longitude,height: where GPS to be spoofed

Therefore, in the present disclosure, the above instructions are combined with a router to generate the GPS spoofing signals.

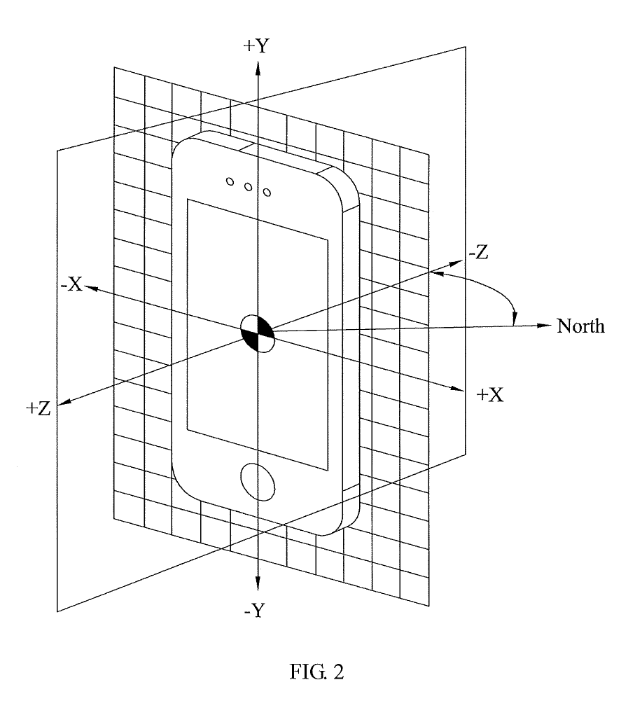

Please refer to FIG. 2, which is a schematic view of a mobile device used in an analysis method for global positioning system, according to an embodiment of the present disclosure.

As shown in FIG. 2, the mobile device in an embodiment is a mobile phone; however, the mobile device of the present disclosure is not limited to this example. In addition, the mobile device of the present disclosure includes an accelerometer and a magnetometer, the accelerometer can be used to acquire acceleration data, and the magnetometer can be used to acquire magnetic data.

The accelerometer can be a gravity sensor that provides a three-dimensional space vector indicating a direction and a magnitude of gravity, and the three-dimensional vector can be expressed as {±x, ±y, ±z} in a Cartesian coordinate system, and ±x means left-right directions, ±y means front-back directions, and ±z means up-down directions.

The magnetometer can display a direction deviation between the North and y-z plane, and a degree of deviation can be in a range of 0 to 360 degrees in the clockwise direction.

In an embodiment, the mobile device of the present disclosure includes various sensors such as the accelerometer, the magnetometer, and the GPS data receiver, so that the mobile device is able to obtain sensing data including acceleration data, magnetic data (that is, the heading direction), and GPS data. The sensed data is transformed into analysis data that includes latitude and longitude (that is, the last GPS data), step frequency (that is, the estimated step count data), estimated step length data, and estimated magnetic data. The analysis data is converted into feature data including a direction error value, a position error value and a movement distance error value. The SVM system performs analysis on the feature data to detect whether GPS spoofing attacks occur; if not, no signal is transmitted or a confirmation signal can be transmitted; otherwise, if it is determined that GPS spoofing attacks occur, the estimated position data can be transmitted.

In an embodiment, the mobile device of the present disclosure can receive GPS signals through the built-in GPS data receiver and may be simultaneously attacked by the GPS spoofing signal. The mobile device can transmit the above-mentioned feature data to the server, so that the server can use the SVM system to analyze and send back a SVM result to the mobile device. If the SVM result indicates that the global positioning system is attacked by the GPS spoofing signal, the estimated position data obtained from a PDR system can be used for correction. The GPS data of the last feature data classified as real value is used as the last GPS data; and, the last GPS data and the feature data are combined and converted into the estimated position data for correction.

Therefore, when pedestrian carries the mobile device with built-in accelerometer, magnetometer and GPS data receiver, it can detect whether the pedestrian area is subject to GPS spoofing attacks and the data collected by the accelerometer, the magnetometer and GPS data receiver are converted to generate the estimated position data. In the present disclosure, the PDR system is selected to estimate a user's location, and compare the user's location with the data obtained by the GPS data receiver, and the feature data including the direction error value, the position error value and the movement distance error value are calculated for SVM classification.

The concept of the PDR system is as follows:

\vec{S}(t+ΔT)=\vec{S}(t)+\vec{V}(t)*ΔT

wherein \vec{S}(t) represents a position at time t, \vec{V}(t) represents a speed at time t, and ΔT represents a time interval between two calculations.

It is not easy to calculate the user's speed according to raw data obtained from the mobile device, so the analysis method of the present disclosure makes the following correction:

\vec{S}(n+1)=\vec{S}(n)+\vec{L}(n)

wherein \vec{S}(n) represents a position vector at the n-th step, and \vec{L}(n) represents a step length vector at the n-th step. The \vec{S}(n) can be obtained from the GPS data receiver, so the analysis method of the present disclosure calculates \vec{L}(n) according to the estimated step count data and the estimated step length data.

The present disclosure uses the accelerometer as a pedometer to calculate a number of steps of a user, so as to obtain the estimated step count data. The sampling rate is set to be 0.1 second, and it means that a set of data including the acceleration data in x, y and z directions and a direction data can be obtained every 0.1 second. When a component of the acceleration data in the z direction is accumulated to a local maximum value and exceeds one third of mean value of the amplitude of the user's step, it determines that one step occurs. In addition, the analysis method of the present disclosure also adds two conditions in the pedometer. The first condition is that every 0.3 second, only one step occurs; and the second condition is that the local maximum value of the acceleration data is higher than 9.8 g/s², so as to prevent from interference of noise of the sensor and the user's meaningless action, thereby improving accuracy of counting the user's steps. The virtual codes for the pedometer of the present disclosure are as follows:

Algorithm 1 pedometer

Require: accelerationZ;accumulationZ;
amplitudeMean;timeElapseSinceLastCount;
Ensure: stepCount;

| | |
|---|---|
| 1: | while every update of accelerationZ do |

| | |
|---|---|
| 2: | if accelerationZ > −9.8 AND accumulationZ > |

0.33*amplitudeMean

AND timeElapseSinceLastCount > 0.3 then

| | |
|---|---|
| 3: | stepCount = stepCount + 1 |
| 4: | UPDATE amplitudeMean |
| 5: | RESET timeElapseSinceLastCount |
| 6: | RESET accumulationZ |

| | |
|---|---|
| 7: | else |

| | |
|---|---|
| 8: | accumulationZ = accumulationZ+accelerationZ |
| 9: | UPDATE timeElapseSinceLastCount |

The user's step length usually changes during walking, so the analysis method of the present disclosure performs dynamic step length calculation in the PDR system to obtain the estimated step length data. In the prior art, the step length can be simulated as a linear combination of step frequency, acceleration amplitude, swing angle, and various constants. However, in the analysis method of the present disclosure, the swing angle cannot be measured because the heading direction of the mobile device may coincide with the walking direction. For this reason, the present disclosure modifies the step length calculation according to the following equation:

StepLength=α·P+β·ω+C

wherein P and ω represent the acceleration amplitude and walking frequency obtained from the acceleration data, respectively, α and β are constants representing the user's gait, and C is a constant representing the user's height.

In the present disclosure, the estimated step count data, the estimated step length data, the GPS data, and the magnetic data obtained from the magnetometer are combined to implement the PDR system as follows:

Algorithm 2 Pedestrian Dead-Reckoning

Require: stepCount;stepLength;longitude;latitude;

heading;Meter2GPS;startLon;startLat;

Ensure: estLongitude;estdLatitude;

| | |
|---|---|
| 1: | initialization; |
| 2: | Meter2GPS = 8.9910 * 10⁻⁶; |
| 3: | startLon = longitude; |
| 4: | startLat = latitude; |
| 5: | while every update of stepCount do |

| 6: | estLongitude = startLon + |
|---|---|
| | stepLength*Sin(heading)*Meter2GPS |
| 7: | estLatitude = startLat + |

stepLength*Cos(heading)* Meter2GPS

As a result, the present disclosure can obtain estimated position data according to the PDR system.

In order to classify the data affected by the GPD spoofing attacks already and the data not affected by the GPD spoofing yet, the data are converted into feature data including direction error values, position error values, and movement distance error values. The position error value is the coordinate difference between the GPS data and the estimated position data. The movement distance error value is an absolute values difference between of the GPS data and the estimated position data. The direction error value is a difference between the magnetic data and the estimated magnetic data.

In one embodiment, when the user is at the coordinate (x′, y′) and the GPS data obtained from the mobile device shows that the user is currently at (x, y), a two points distance formula d\hat{ }2=(x−x′)\hat{ }2+(y−y′)\hat{ }2, can be used to calculate a distance d between two coordinates, and the unit of the distance d is converted into meter. The converted distance d is served as the position error described above.

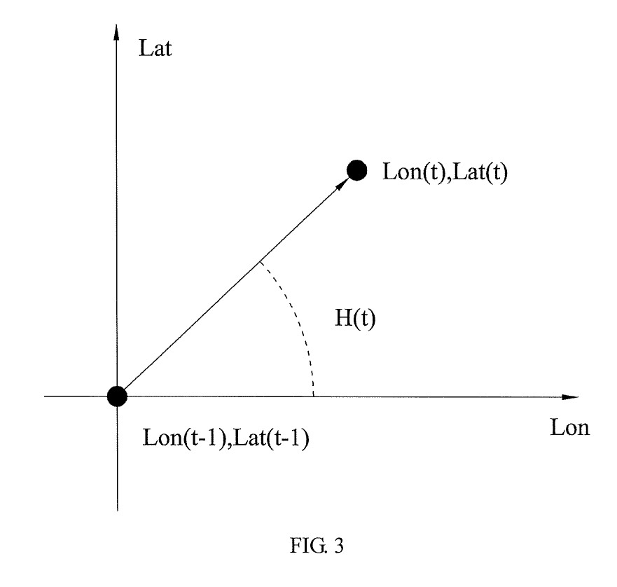

In an embodiment, the DR equation L′=n× l, can be used to calculate the distance, and n represents the number of steps, and l represents the step length, and a total distance L′ is a product of the step number and the step distance, so as to estimate the user's total distance L′ during walking. At the same time, the GPS data is also used to calculate a distance according to an equation L=m× Xi, and m represents a total walking time in unit of second, Xi represents a distance between the user's coordinates at each time point and previous time point, and the total distance L is a product of the total time and the distance, that is, the total distance L traveled by the user. Next, an absolute value of the difference between the distance calculated according the GPS data and the distance calculated according to the DR equation is the absolute position difference of the present disclosure. Please refer to FIG. 3, which is a schematic view of the estimated magnetic data of the analysis method for global positioning system, according to an embodiment of the present disclosure.

The estimated magnetic data of the present disclosure can be obtained according to FIG. 3 in cooperation with the following:

$$H ( t ) = arctan 2 ( \frac{Lat ( t ) - Lat ( t - 1 )}{γ} , \frac{Lon ( t ) - Lon ( t - 1 )}{γ} )$$

wherein H(t) represents the estimated magnetic data at time t, Lat(t) represents the latitude at time t, Lat(t−1) represents the latitude at time (t−1), Lon(t) represents the longitude at time t, the Lon(t−1) represents the longitude at time (t−1), y represents a GPS conversion constant, and arctan represents an arctangent of the direction. The mobile phone is set to periodically acquire the user's GPS position; preferably, the acquirement period can be in a range of 0.01 seconds to 2 seconds. In this embodiment, the mobile device is a mobile phone and the acquirement period can be one second. The user is at the coordinate (Lat(t−1), Lon(t−1)) at the (t−1)th second, and at the coordinate (Lat(t), Lon(t)) at the t-th second, and these two coordinates are subtracted with each other to obtain a difference, and the difference is divided by γ to obtain the difference in a unit of meter. Next, the difference is inputted into a trigonometric function arctan 2 to calculate a specific angle of the user's direction. The specific angle can be in a range of 0 to 360 degrees, and the calculated H(t) is a direction with an angle in a range of 0 to 360 degrees. The angles of the magnetic data and H(t) are subtracted with each other to obtain the estimated magnetic data.

The analysis method of the present disclosure uses the PDR system to estimate the user's position, and calculate the feature data including the direction error value, the position error value and the movement distance error value for further SVM classification. The detail of the analysis method will be described in reference with an embodiment.

In a preferred embodiment, a python server and an iOS-APP user terminal are built to collect the data from the mobile device. The iOS-APP is performed to collect the data every 0.1 seconds and store the collected data in a local file, and the recorded file is then uploaded to the python server for SVM classification.

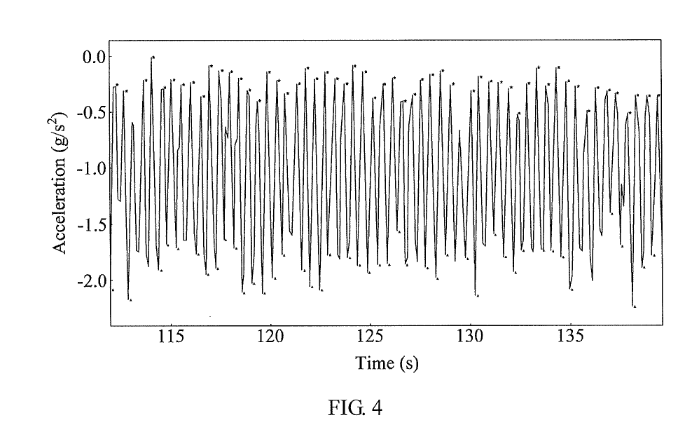

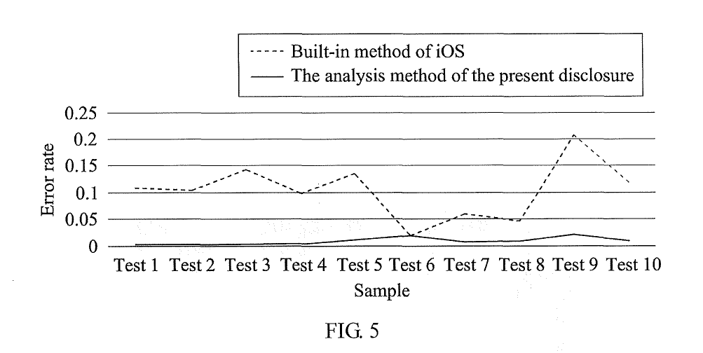

Please refer to FIGS. 4 and 5, which show analysis views of the estimated step count data of the analysis method for GPS, according to a preferred embodiment of the present disclosure.

The iOS system includes a built-in method of calculating the step count, but the accuracy of the built-in method is not good enough and the built-in method is unable to perform detection in real time. For this reason, the analysis method of the present disclosure uses the accelerometer as the pedometer to calculate the user's step count, so as to obtain the estimated step count data. FIG. 4 shows the values of the acceleration in z direction and the calculation points of the estimated step count data. These calculation points are marked by star symbols. FIG. 5 shows the data calculated by the method built in the iOS system and the estimated step count data of the present disclosure, to compare the accuracies of these two methods. The baseline indicates the step count calculated manually.

The way of calculating the error rate is as following:

error rate=abs(counted#−real#)/real#

As shown in FIG. 5, the error rate of the estimated step count data of the present disclosure is lower than 1%, and the error rate of the method built in the iOS system is higher than 10%, so the analysis method of the present disclosure can indeed obtain more accurate step count, compared with the prior art.

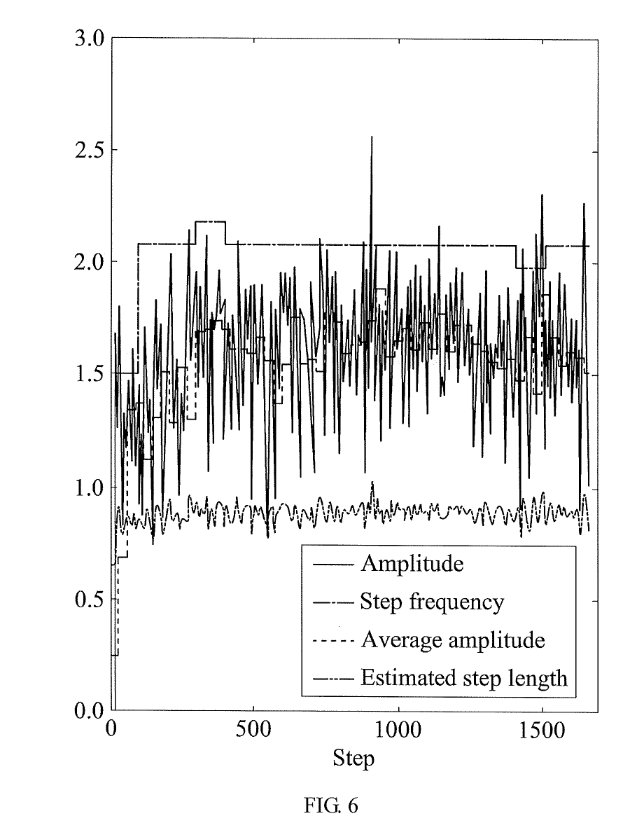

Please refer to FIG. 6, which is an analysis view of the estimated step length data in the analysis method for GPS, according to a preferred embodiment of the present disclosure.

In the preferred embodiment, a male adult of 170 cm in height and having correct gait is selected as a test example for obtaining constants α and β representing the user's gait and constants C representing the user's height. In the analysis method of the present disclosure, a measurement procedure for the movement distance error is established to measure the difference between the GPS data and the estimated position data. Next, a greedy algorithm is used to approximate the parameters and generate parameters for estimating the step length data by minimizing the moving distance error value when the estimated step number is 7000 steps. In the preferred embodiment, the constant α is 10.7, the constant β is 14.8, and the constant C is 49, and these constant values are used in the preferred embodiment to calculate estimated step length data.

In the preferred embodiment, the process that GPS spoofing attacks start until the mobile device is spoofed spends about two to three minutes. In order to obtain enough spoofing data for analysis, the analysis method of the present disclosure establishes a simulator to generate the simulation data.

The user can hold the mobile device and walk outdoors, and the built-in sensor of the mobile device can record the acceleration data, the magnetic data and the GPS data. Then, the analysis method of the present disclosure uses python coding to convert the route information of the Google map into GPGGA-formatted data, and uses the original coding to parse and convert the GPGGA data into binary data and sends it to HackRF which then produces a false signal to cover the real GPS signal. Next, the spoofed mobile receives the false GPS data. At the same time, the spoofed mobile device can still record the correct acceleration data and magnetic data. Finally, the simulator of the present disclosure will mix the false signal, which is converted by the above coding, with the true signal. This simulation step skips the signal transmission process of the HackRF and can provide enough spoofing data.

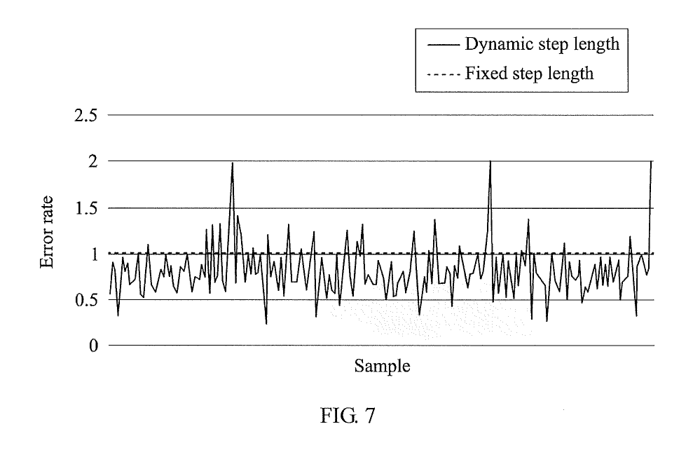

Please refer to FIG. 7, which is an analysis view showing estimated step length data in the analysis method for GPS, according to a preferred embodiment of the present disclosure.

As shown in FIG. 7, the analysis method of the present disclosure is to test an example to measure the position error value within 70 seconds. In this embodiment, the fixed step length is 0.7 meters and the number of experimental walks is 214 times. The average error between the user's position predicted by the dynamic step distance method and the position of the GPS data is 8.04 meters, and the average walking distance of the 214 experiments is 101.38 meters. It can be seen that the dynamic step length estimation of the present disclosure can reduce error from 10.66 meters to 8.04 meters, and the average error rate is 7.93%. As a result, the dynamic step length estimation of the present disclosure can effectively improve the accuracy of the estimated step length data even if the mobile device operated by the user is spoofed by GPS spoofing signals.

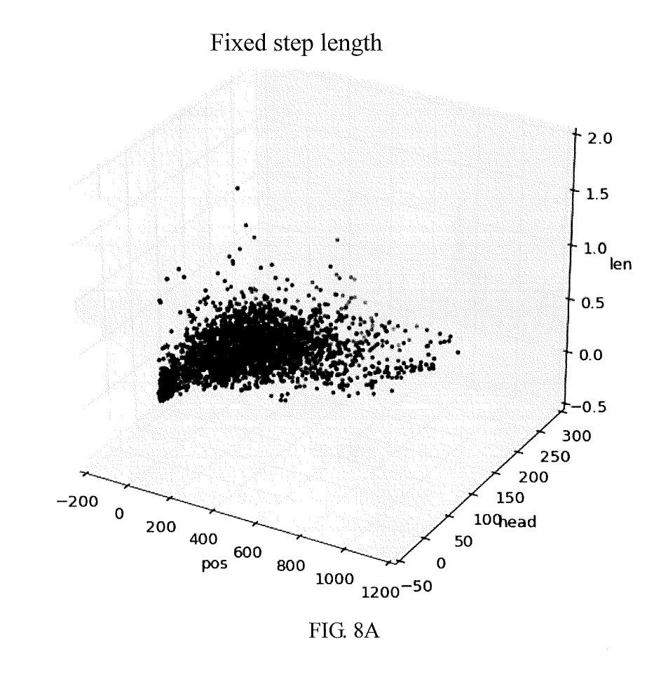

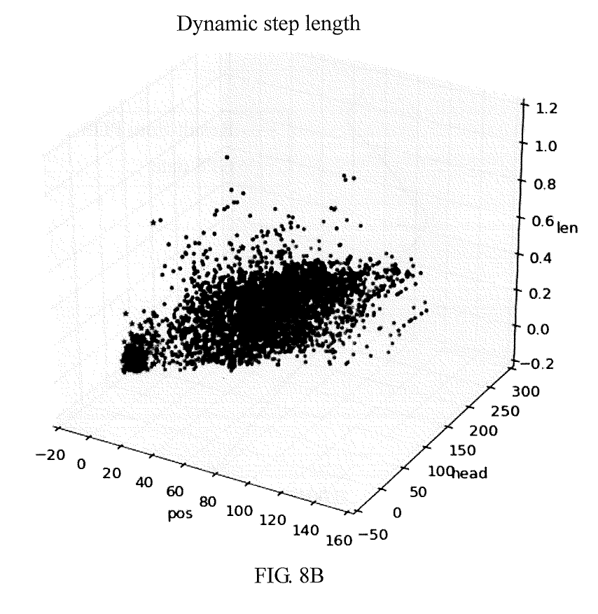

Please refer to FIGS. 8A and 8B, which are separability analysis views of the analysis method for GPS, according to a preferred embodiment of the present disclosure.

In order to enhance the separability of data classification, the analysis method of the present disclosure uses a J3 value as a criterion for separability to measure the separability of the analysis method of the present disclosure. When the J3 value is higher, it indicates the separability of the data is higher. As shown in FIG. 8A, the J3 value of the fixed step length is 8.4171; in the other hands, as shown in FIG. 8b, the J3 value of the dynamic step estimate increases to 20.4215. As a result, compared with the prior art, the estimated step length data obtained by the dynamic step estimation of the present disclosure has higher data separability for the machine learning.

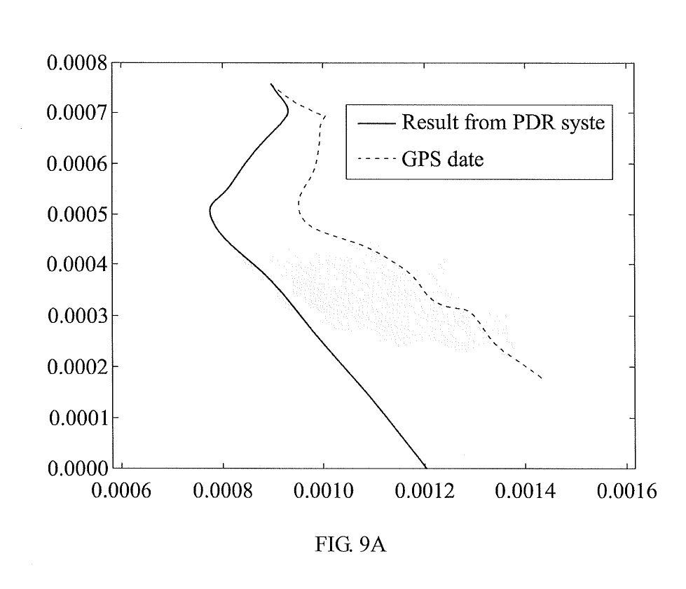

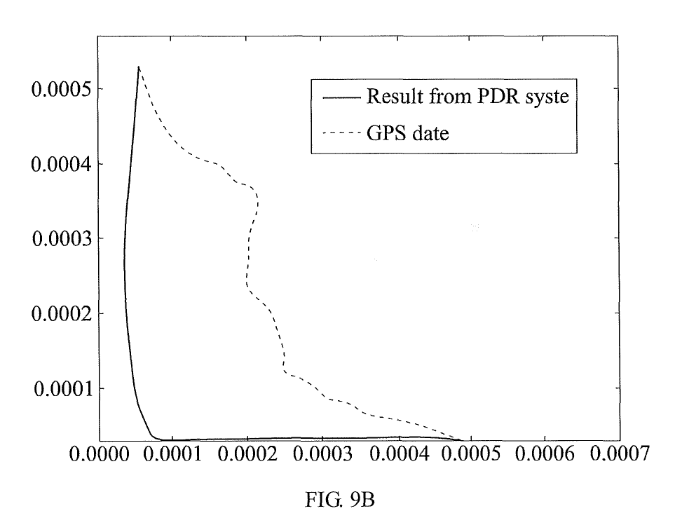

Table 1 is a confusion matrix of the present disclosure. Please refer to FIGS. 9A and 9B, which are test analysis views of an analysis method for GPS, according to a preferred embodiment of the present disclosure.

TABLE 1

| N = 5815 | Predict: spoof | Predict: normal |
|---|---|---|
| Actual: spoof | TP = 2931 | FN = 28 |
| Actual: normal | FP = 122 | TN = 2757 |

As show in table 1, the positive rate (TP/(TP+FN)) is 99.05%, the false positive rate (FP/(FP+TN)) is 4.237%, the accuracy is ((TP+TN)/N) is 97.43%, the precision (TP/(TP+FP)) is 96.00%, and the recall (TP/(TP+FN)) is 99.05.

In the preferred embodiment, the mixing ratio of the false signal to the true signal is 1:1. In the case of a number of total signals exceeds 5815, the false positive rate is 4.237%. The thick line represents a result calculated by the PDR system, and the thin line represents the GPS data results. As shown in FIG. 9A, a reason for the higher false positive rate is that the user walks around a 9-story building, and it results in unstable GPS data received by the GPS receiver. As shown in FIG. 9B, a reason for the higher false positive rate is that the value of the initial direction error increases the walking error value when the walking distance is long.

During correction, the analysis method of the present disclosure generates an error of less than 8.7 meters within a travel time of 70 seconds. The difference between the results calculated by the PDR system and the Google map data is very small. In addition, when the number of steps is 1176, the final error is 28.97 meters. The error is reduced to 16.30 meters when correction is performed every 2 minutes.

By using the HackRF, the analysis method of the present disclosure can be confirmed to effectively detect and correct GPS spoofing attacks. The HackRF has an operating frequency of 1 MHz to 6 GHz and can cover the GPS L1 frequency, so the HackRF can be used to generate spoofing signals. However, the built-in oscillator of the HackRF has a tolerance of 20 ppm and the GPS signal simulator requires an accuracy of at least less than 1 ppm, so the analysis method of the present disclosure uses a TCXO oscillator to increase the tolerance of HackRF to 0.5 ppm. Therefore, the analysis method of the present disclosure can start GPS spoofing attacks without additional tests or frequency setting. In the embodiment, the HackRF is installed on an Intel NUC with Ubnutu 14.04 and the GPS data is converted to GPGGA data, so that the specified route information in the Google map can be used to start spoofing attacks.

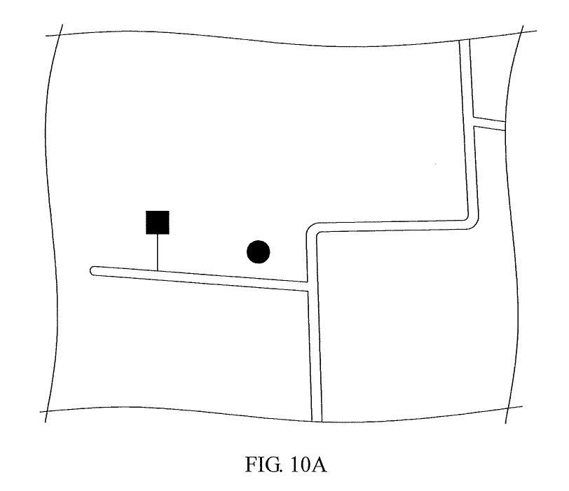

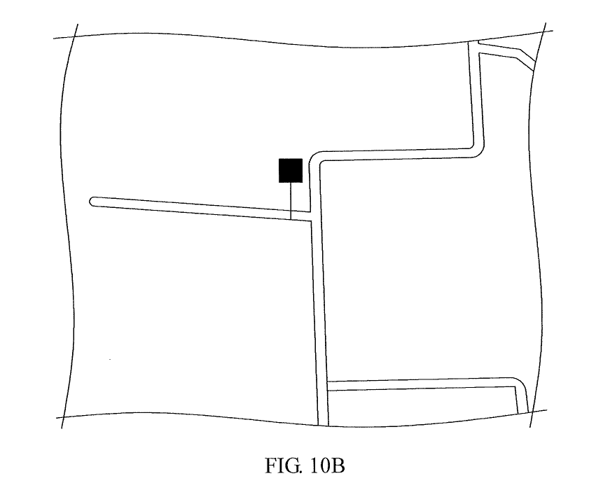

Please refer to FIGS. 10A and 10B, which are test views of an analysis method for GPS according to a preferred embodiment of the present disclosure. The dots represent the GPS data, and the squares represent the estimated location data calculated using the PDR system of the present disclosure. Under a condition that the global positioning system is subject to GPS spoofing attacks, the dots representing the GPS data are out of control, but the squares calculated by the PDR system of the present disclosure remain stable. Under a condition that the GPS spoofing attack succeeds, the dot moves to the wrong place fabricated by the GPS spoofing signal, so the dot disappears from the original but the square remains in place. Obviously, the analysis method for the global positioning system of the present disclosure can effectively detect GPS spoofing attacks and correct location data.

The present disclosure disclosed herein has been described by means of specific embodiments. However, numerous modifications, variations and enhancements can be made thereto by those skilled in the art without departing from the spirit and scope of the disclosure set forth in the claims.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. An analysis method for a global positioning system, comprising:
operating a mobile device comprising an accelerometer, a magnetometer and a GPS data receiver, and using the GPS data receiver to receive GPS data, using the accelerometer to obtain acceleration data, and using the accelerometer to obtain magnetic data;
transmitting the GPS data, the acceleration data and the magnetic data from the mobile device to a server;
combining and converting the GPS data, the acceleration data and the magnetic data into a direction error value, a position error value and a movement distance error value;
executing a support vector machine (SVM) system installed in the server, to compare the direction error value, the position error value and the movement distance error value with a predetermined threshold for classification, wherein the predetermined threshold is adjustable upon a user's height and gait;
transmitting, from the server, a confirmation signal or not transmitting any signal when the direction error value, the position error value and the movement distance error value are classified into true values;
transmitting estimated position data from the server to the mobile device for correction when the direction error value, the position error value and the movement distance error value are classified into false values, and defining the GPS data of the position error value and/or the movement distance error value classified into true values as final GPS data, and combining and converting the final GPS data with the acceleration data and the magnetic data to generate the estimated position data.

2. The analysis method according to claim 1, wherein the direction error value is a difference between the magnetic data and estimated magnetic data calculated according to an equation 1, and the equation 1 is as following:
$$H ( t ) = arctan 2 ( \frac{Lat ( t ) - Lat ( t - 1 )}{γ} , \frac{Lon ( t ) - Lon ( t - 1 )}{γ} )$$
wherein H(t) represents the estimated magnetic data at time t, Lat(t) represents a latitude at time t, Lat(t−1) represents a latitude at time (t−1), Lon(t) represents a longitude at time t, Lon(t−1) represents a longitude at time (t−1), γ represents a GPS conversion constant, and arctan represents an arctangent of the direction.

3. The analysis method according to claim 1, wherein the position error value is a coordinate difference between the GPS data and the estimated position data.

4. The analysis method according to claim 1, wherein the movement distance error value is an absolute value difference between the GPS data and the estimated position data.

5. The analysis method according to claim 3 or 4, wherein the estimated position data is calculated according to the estimated step count data, the estimated step length data, the estimated magnetic data and the final GPS data.

6. The analysis method according to claim 5, wherein the estimated step count data matches estimated step count conditions, and the estimated step count conditions include that sampling rate is 0.1 seconds, one step occurs when an accumulated component of the acceleration data in a z direction reaches a local maximal value and exceeds one third of a mean of amplitude, only one step occurs in every 0.3 second, and a local maximal value of the acceleration data is higher than 9.8 g/s².

7. The analysis method according to claim 5, wherein the estimated step length data calculated according to an equation 2, and the equation 2 is as following:
StepLength=α·P+β·ω+C
wherein P and ω represent an amplitude of acceleration and a walking frequency obtained by the acceleration data, respectively, α and β are constants representing the user's gait, and C is a constant representing the user's height.
